(19) United States
(12) Patent Application Publication
(10) Pub. No.: US 2003/0177944 A1
(43) Pub. Date: Sep. 25, 2003

(54) Inkjet dyes

(76) Inventors: Klaus Kunde, Neunkirchen (DE); Stefan Ehrenberg, Hattersheim (DE)

Correspondence Address: BAYER CHEMICALS CORPORATION, 100 BAYER ROAD, PITTSBURGH, PA, 15205, US

(21) Appl. No.: 10/366,038

(22) Filed: Feb. 13, 2003

(30) Foreign Application Priority Data
Feb. 18, 2002 (DE) 10206564.0

(51) Int. Cl. C09D 11/02; C09B 45/14; C09B 29/00; C09B 45/00; G01D 11/00

(52) U.S. Cl. 106/31.51; 534/722; 534/720; 8/682; 8/683; 8/685; 347/100

(57) ABSTRACT

Compounds of the formula I

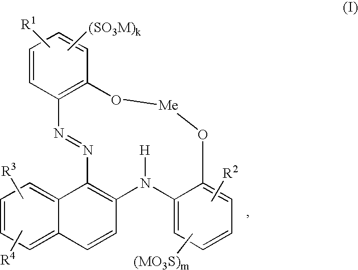

in which

R¹ and R² independently of one another stand for hydrogen or an arbitrary radical, in particular, independently of one another, hydrogen, chloro, C₁-C₄ alkyl, such as methyl, ethyl, n-propyl, i-propyl, n-butyl, i-butyl, tert-butyl, C₁-C₄ alkoxy, such as methoxy, ethoxy, n-propyloxy, i-propyloxy, carboxyl, sulphamoyl, mono- or dialkylsulphamoyl, especially mono- or di-(C₁-C₄ alkyl)sulphamoyl, optionally substituted alkylsulphonyl, especially C₁-C₄ alkylsulphonyl, or SO₃M, and preferably denote hydrogen or sulphamoyl,

R³ denotes hydrogen, hydroxyl, carboxyl or SO₃M,

R⁴ denotes hydrogen or SO₃M,

k and m independently of one another denote 0 or 1,

Me stands for copper, cobalt or chromium, copper and cobalt preferably being in oxidation state +2 and chromium preferably in oxidation state +3, preferably for copper and cobalt, and with particular preference for copper, and

M represents hydrogen, alkali metal, such as sodium, potassium or lithium, or optionally substituted ammonium.

### BACKGROUND OF THE INVENTION

The invention relates to novel dyes, to a process for preparing them and to their use for dyeing and printing cellulosic materials, natural or synthetic polyamides and leather.

### DESCRIPTION OF THE INVENTION

The dyes of the invention are of the general formula I

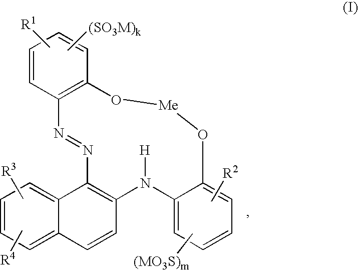

in which

R¹ and R² independently of one another stand for hydrogen or an arbitrary radical, in particular, independently of one another, hydrogen, chloro, nitro, C₁-C₄ alkyl, such as methyl, ethyl, n-propyl, i-propyl, n-butyl, i-butyl, tert-butyl, C₁-C₄ alkoxy, such as methoxy, ethoxy, n-propyloxy, i-propyloxy, carboxyl, sulphamoyl, mono- or dialkylsulphamoyl, especially mono- or di-(C₁-C₄ alkyl)sulphamoyl such as methyl-, ethyl-, dimethyl- or diethylsulphamoyl, optionally substituted alkylsulphonyl, especially C₁-C₄ alkylsulphonyl such as methyl- or ethylsulphonyl or hydroxyethyl sulphonyl or SO₃M, and preferably denote hydrogen or sulphamoyl,

R³ denotes hydrogen, hydroxyl, carboxyl or SO₃M,

R⁴ denotes hydrogen or SO₃M,

k and m independently of one another denote 0 or 1,

Me stands for copper, cobalt, nickel or chromium, copper and nickel preferably being in oxidation state +2 and cobalt and chromium preferably in oxidation state +3, preferably for copper and cobalt, and

M represents hydrogen, alkali metal, such as sodium, potassium or lithium, or optionally substituted ammonium.

Particularly preferred ammonium salts are those in which from 1 to 4 hydrogen atoms have been replaced by identical or different C₁-C₆ alkyl radicals or by C₂-C₆ alkyl radicals substituted by hydroxyl or C₁-C₃ alkoxy groups. Preferred alkanolammonium and alkylammonium salts include the following: H₃^{⊕}NCH₂CH₂OH, H₂^{⊕}N(CH₂CH₂OH)₂, H^{⊕}N(CH₂CH₂OH)₃, ^{⊕}N(CH₂CH₂OH)₄, H^{⊕}N(CH₃)(CH₂CH₂OH)₂, H^{⊕}N(CH₃)₂(CH₂CH₂OH), ^{⊕}N(CH₃)₄, H^{⊕}N(C₂H₅)(CH₂CH₂OH)₂ and ^{⊕}N(CH₂CH₃)₄.

The dyes of the invention serve in particular as dyes in inkjet inks; their outstanding lightfastness is noteworthy.

Particularly preferred dyes of the invention are those of the general formula (I) which are of the formulae (Ia) or (Ib)

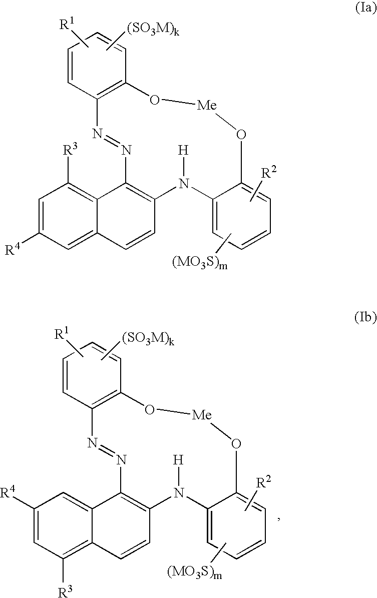

in each of which

k, m, Me and M are as defined above,

R³ stands for hydrogen or hydroxyl,

R⁴ stands for SO₃M and

R¹ and R² independently of one another stand for hydrogen or sulphamoyl.

The present invention further relates to a process for preparing the dyes of the formula (I) which is characterized in that an amino compound of the formula (II)

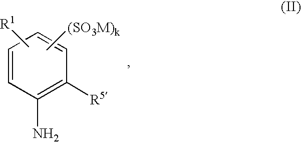

in which

R⁵′ denotes hydrogen, methoxy or hydroxyl and

M, R¹ and k are as defined above is diazotized and the product is coupled with a compound of the formula III

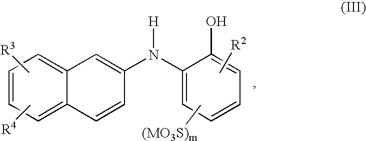

in which

R², R³, R⁴, M and m are as defined above,

preferably at a temperature from 0° C. to 50° C., more preferably from 10° C. to 40° C., and at a pH of less than 6, preferably from 0.5 to 4.0, and is subsequently reacted with copper, cobalt or chromium donors.

Examples of amines of the formula II that are used as diazo components in the process of the invention include the following: 2-aminophenol, 2-aminophenol-4-sulphonic acid, 2-aminophenol-6-sulphonic acid, 2-amino-4-methylphenol, 3-amino-4-hydroxybenzoic acid, 3-amino-4-hydroxybenzoic acid, 3-amino-2-hydroxybenzoic acid, 4-amino-3-hydroxybenzoic acid, 2-aminophenol-4-sulphonamide, 2-aminophenol-5-sulphonic acid, 2-aminophenol-5-sulphonamide, aniline, sulphanilic acid, metanilic acid, o-anisidine, 2-methoxyaniline-4-sulphonic acid, 2-methoxyaniline-5-sulphonic acid, 2-amino-4-chlorophenol, 2-amino-4-nitrophenol, 2-amino-5-nitrophenol.

Examples of preferred coupling components of the formula (III) include 1-hydroxy-7-(2′-hydroxyphenyl)amino-3-naphthalenesulphonic acid, 1-hydroxy-6-(2′-hydroxyphenyl)amino-3-naphthalenesulphonic acid, 7-(2′-hydroxyphenyl)amino-3-naphthalenesulphonic acid, 6-(2′-hydroxyphenyl)amino-3-naphthalenesulphonic acid, 1-hydroxy-7-(2′-hydroxy-4′-sulphamoylphenyl)amino-3-naphthalenesulphonic acid, 1-hydroxy-6-(2′-hydroxy-4′-sulphamoylphenyl)amino-3-naphthalenesulphonic acid, 6-(2′-hydroxy-4′-sulphamoylphenyl)amino-3-naphthalenesulphonic acid, 7-(2′-hydroxy-4′-sulphamoylphenyl)amino-3-naphthalenesulphonic acid, 2-(2′-hydroxyphenyl)amino-5,7-naphthalenesulphonic acid, 2-(2′-hydroxy-4′-sulphamoylphenyl)amino-5,7-naphthalenesulphonic acid, 1-hydroxy-7-(2′-hydroxy-4′-N,N-dimethylsulphamoylphenyl)amino-3-naphthalenesulphonic acid.

The coupling components of the formula III may be prepared, for example, by the Bucherer reaction of the corresponding naphthols or naphthylamines with 2-aminophenols of the general formula (IV)

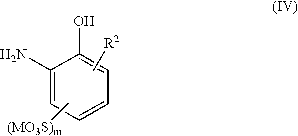

in which

M, R² and m are as defined above.

The conditions of the Bucherer reaction are known per se, described for example in GB-A-230 457 and CS 155758; it takes place preferably in water at a temperature from 80° C. to 130° C., with particular preference at from 100 to 130° C., in the presence of sodium hydrogen sulphite.

Starting compounds for the Bucherer reaction are, for example, 1-hydroxy-7-amino-naphthalene-3-sulphonic acid, 1,7-dihydroxynaphthalene-3-sulphonic acid, 2-amino-naphthalene-6-sulphonic acid, 2-aminonaphthalene-5-sulphonic acid, 2-hydroxynaphthalene-6-sulphonic acid, 2-hydroxynaphthalene-5-sulphonic acid, 1,6-dihydroxynaphthalene-3-sulphonic acid, 2-hydroxynaphthalene-7-sulphonic acid, 2-aminonaphthalene-7-sulphonic acid, 1-hydroxy-6-aminonaphthalene-3-sulphonic acid, 2-aminonaphthalene-5,7-disulphonic acid, 2-hydroxynaphthalene-5,7-disulphonic acid

and 2-aminophenol, 2-aminophenol-4-sulphonic acid, 2-aminophenol-6-sulphonic acid, 2-amino-4-methylphenol, 3-amino-4-hydroxybenzoic acid, 3-amino-4-hydroxybenzoic acid, 3-amino-2-hydroxybenzoic acid, 4-amino-3-hydroxybenzoic acid, 2-aminophenol-4-sulphonamide and 2-aminophenol-5-N,N-dimethylsulphonamide.

In one preferred embodiment the process for preparing the coupling component of the formula m is characterized in that a compound of the formula (V)

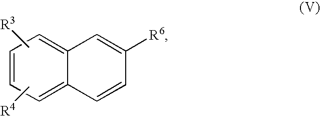

in which

R³ and R⁴ are as defined above and

R⁶ denotes hydroxyl or amino is reacted together with a compound of the general formula (IV)

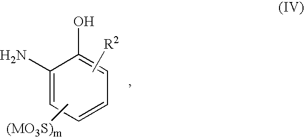

in which

M, R² and m are as defined above,

in water and aqueous sodium hydrogen sulphite solution, preferably from 30 to 40% strength by weight, in particular from 35 to 39% strength by weight and aqueous sodium hydroxide solution, preferably from 20 to 50% strength by weight, in particular from 33 to 50% strength by weight, at a pH from 5 to 7, preferably from 5.2 to 6.5.

Following the addition of sodium chloride where appropriate, the reaction mixture is heated at boiling under reflux. After cooling to room temperature, the product of the formula (III) is isolated.

The conditions for the diazotization of the compounds of the formula (II), and also of the coupling with the compound of the formula (III), are known per se to the person skilled in the art, and they can be performed in a conventional manner which is described at length in the relevant literature.

The components of the formula (II) are diazotized preferably in an aqueous medium at temperatures from −5° C. to +20° C. and at pH values from 0 to 2. The coupling takes place preferably likewise in aqueous medium at temperatures from 0° C. to +30° C. and at pH values from 0 to 4. The coupling product may be precipitated by adding sodium chloride, although it can also be passed on for formation of the metal complex without being isolated.

The invention further relates to the azo compound obtained prior to metallation, of the formula VI

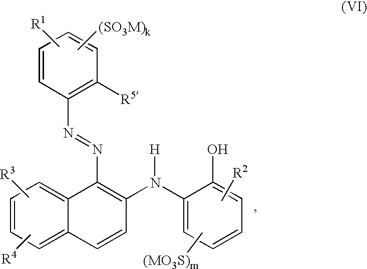

in which

M, R¹, R², R³, R⁴, R⁵′, m and k are as defined above.

The azo compound of the formula (VI) serves preferably as an intermediate in the preparation of compounds of the formula (I).

The invention further relates to a process for preparing compounds of the formula VI which is characterized in that an amino compound of the formula II is diazotized and the product is reacted with a coupling component of the formula III.

The diazotization and coupling conditions are subject to the comments made above.

The compounds of the formula VI according to the invention are then treated preferably with a copper, cobalt or chromium donor, where appropriate in the presence of an oxidizing agent or where appropriate in the presence of a demethylating agent. This reaction with agents which donate copper, cobalt or chromium takes place in analogy to the known processes of metal complex syntheses.

Azo compounds of the formula VI are preferably treated with the metal donors in an aqueous medium at a temperature from 0 to 130° C., where appropriate with reflux cooling or in a closed vessel under pressure.

If the metal complex formation reaction is carried out as an oxidative coppering, i.e. if in the compounds of the formula VI the formula radical R⁵′ stands for a hydrogen atom, it is preferred to add a customary oxidizing agent.

The metal donors used in the metal complex formation process of the invention are, for example, salts of copper, of cobalt and of chromium which are capable of releasing the said metal in the form of a cation to the complexation-capable hydroxyl groups in the compounds of the formula (I) which may have formed in the oxidative or dealkylating metallation, and so include, for example, copper sulphate, copper carbonate, cobalt sulphate, cobalt acetate, cobalt(II) hydroxide and chromium sulphate; these compounds suitable as metal complex formers also include organic hydroxycarboxylic acids or dicarboxylic acids which contain the metal in complexed form, examples being complex chromium or cobalt compounds of aliphatic hydroxycarboxylic acids or aliphatic dicarboxylic acids, especially of alkanes of from 2 to 6 carbon atoms, or chromium complex compounds of aromatic o-hydroxy-carboxylic acids, such as, for example, the chromium or cobalt complex compounds of salicylic acid, of citric acid, of lactic acid, of glycolic acid or of tartaric acid.

The deposition and isolation of the azo compounds of the general formula I according to the invention from the aqueous synthesis solutions can be carried out in accordance with conventional methods for water-soluble compounds, for example by precipitation from the reaction medium by means of an electrolyte, such as sodium chloride or potassium chloride, for example, or by evaporative concentration of the reaction solution itself, by spray drying, for example. Where the last-mentioned mode of isolation is chosen, it is in many cases advisable to remove any foreign salts that are present in the solutions by pressure permeation prior to evaporative concentration.

Aqueous dye preparations of dyes of the formula I may be prepared by dissolving the dye salts in water where appropriate after and/or during a desalination, for example by pressure permeation and/or by addition of one or more of the abovementioned organic solvents, where appropriate at elevated temperatures (from 30 to 100° C., in particular 30 to 50° C.) and with the addition of organic and inorganic bases; where appropriate, customary ionic or nonionic additives may be used as well, examples being those which can be used to raise or lower the viscosity.

Instead of the salts of (I) it is also possible to use the corresponding free acids, preferably in combination with equimolar or higher amounts of the corresponding organic or inorganic bases.

Preferred organic bases are alkanolamines and quaternary ammonium compounds such as, for example, 2-aminoethanol, diethanolamine, triethanolamine, N-methyl-diethanolamine, tetramethylammonium hydroxide and tetraethylammonium hydroxide.

Preferred organic solvents are alcohols and their ethers or esters, carboxamides, ureas, sulphoxides and sulphones, especially those having molecular weights <200 g/mol. Examples of particularly suitable solvents are methanol, ethanol, propanol; ethylene, propylene, diethylene, thiodiethylene and dipropylene glycol; butanediol; B-hydroxypropionitrile, pentamethylene glycol, ethylene glycol monoethyl and monopropyl ether, ethylene diglycol monoethyl ether, triethylene glycol monobutyl ether, butyl polyglycol, formamide, triethylene glycol, 1,5-pentanediol, 1,3,6-hexanetriol, 2-hydroxyethyl acetate, 2-(2′-hydroxyethyl)ethyl acetate, glycerol, glycol acetate, 1,2-dihydroxypropane, 1-methoxy-2-propanol, 2-methoxy-1-propanol, N,N-dimethylformamide, pyrrolidone, N-methylcaprolactam, ε-caprolactam, N-ethylcaprolactam, butyrolactone, urea, tetramethylurea, 1,3-dimethyl-2-imidazolidinone, N,N′-dimethylolpropyleneurea, dimethyl sulphoxide, dimethyl sulphone, sulpholane, isopropanol and polyethylene glycol.

The dyes of the formula (I) according to the invention are particularly suitable for preparing printing inks which can be used in particular as fluids for recording by the inkjet method.

The invention therefore further provides printing inks, i.e. aqueous dye preparations comprising at least one dye (I), and also for their use as a recording fluid for inkjet recording systems, particularly for producing blue or black prints.

The inkjet method of the process of the invention is understood to be an inkjet recording process in which the drops of ink are sprayed onto a substrate. The fine ink droplets may be produced by a variety of methods. They are preferably produced by the conventional thermal-jet, bubble jet, piezo-jet or valve-inkjet methods.

Where the dyes of the invention are used in the form of their aqueous preparations as a recording fluid for inkjet recording systems, the following advantages arise: the physical properties, such as viscosity, surface tension and the like, are within the appropriate ranges; the recording fluid does not cause any blockages in fine dispensing apertures of inkjet recording equipment; it gives images of high density; when the recording fluid is stored, there is no change in physical properties and no deposition of solid constituents; the recording fluid is suitable for recording on different recording media without restrictions as to the type of recording media; finally, the recording fluid fixes rapidly and gives images having excellent water resistance, lightfastness, abrasion resistance and resolution. The aqueous dye preparations generally contain from about 0.5 to 20% by weight of one or more dyes of the formula (I) and from 80 to 99.5% by weight of water and/or solvents and also, where appropriate, further customary constituents.

The invention is further illustrated but is not intended to be limited by the following examples in which all parts and percentages are by weight unless otherwise specified.

### EXAMPLES

I. Preparation of the Coupling Component by the Bucherer Reaction

a.) 0.474 mol of 1,7-dihydroxynaphthalene-3-sulphonic acid, 0.57 mol of 2-aminophenol, 380 ml of water and 873 ml of 39% strength sodium hydrogen sulphite solution are adjusted to a pH of 5.7 using 33% strength sodium hydroxide solution. Following the addition of 150 g of sodium chloride the reaction mixture is heated at boiling under reflux at 107° C. for 20 hours. After cooling to room temperature, the product of the formula (3.1)

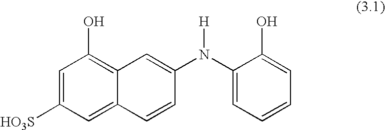

is isolated, washed with saturated sodium chloride solution and dried. Using as the naphthol component an equimolar amount of 1,6-dihydroxy-3-naphthalenesulphonic acid gives the product of the formula (3.2).

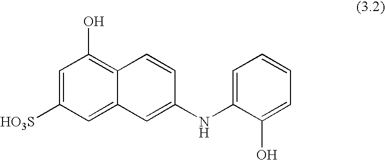

b.) 0.495 mol of 2-naphthol-7-sulphonic acid, 0.694 mol of 2-aminophenol-4-sulphonic acid, 400 ml of water and 921 ml of 39% strength sodium hydrogen sulphite solution are adjusted to a pH of 5.8 using 33% strength sodium hydroxide solution. Following the addition of 200 g of sodium chloride the reaction mixture is heated at boiling under reflux for 20 hours.

After cooling to room temperature, the product of the formula (3.3)

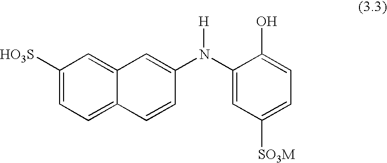

is isolated, washed with saturated sodium chloride solution and dried.

Using as the naphthol component an equimolar amount of 2-hydroxy-6-naphthalenesulphonic acid gives the product of the formula (3.4).

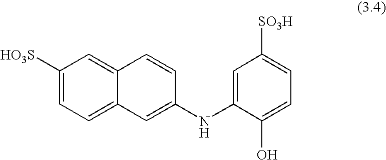

c.) 0.474 mol of 1,7-dihydroxynaphthalene-3-sulphonic acid, 0.57 mol of 2-aminophenol-4-sulphonamide, 380 ml of water and 873 ml of 39% strength sodium hydrogen sulphite solution are adjusted to a pH of 5.7 using 33% strength sodium hydroxide solution. Following the addition of 300 g of sodium chloride the reaction mixture is heated at boiling under reflux for 20 hours. After cooling to room temperature, the product of the formula (3.5)

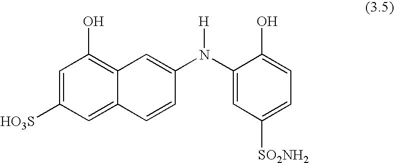

is isolated, washed with saturated sodium chloride solution and dried.

Using as the naphthol component an equimolar amount of 1,6-dihydroxy-3-naphthalenesulphonic acid gives the product of the formula (3.6).

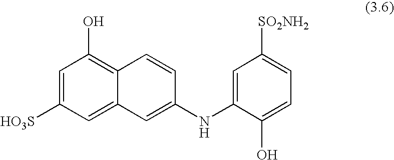

II. Preparation of the Dyes

1) 94.5 g of 2-aminophenol-4-sulphonamide are introduced into an initial charge of 300 ml of water, 75 ml of hydrochloric acid (30%) and 150 g of ice, the components are stirred together and diazotization is performed by adding 35 g of sodium nitrite. 205 g of the coupling component of the formula (3.5) are suspended at room temperature in 300 ml of water and this suspension is added to the suspension of the diazonium compound. The pH of the suspension is brought to 2 by adding sodium acetate. It is stirred at room temperature for 5 hours and a saturated solution of 125 g of copper(II) sulphate pentahydrate in water is added. The dye of the formula (4.1)

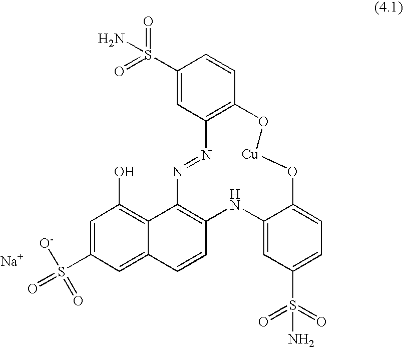

is isolated; the product is converted into a neutral solution using sodium hydroxide solution and is freed from all electrolytes by ultrafiltration. The concentrated solution is used to prepare a dark-blue inkjet ink.

2) 94.5 g of 2-aminophenol-4-sulphonic acid are introduced into an initial charge of 100 ml of water, 5 ml of hydrochloric acid (30%) and 200 g of ice, the components are stirred together and diazotization is performed by adding 35 g of sodium nitrite. 166 g of the coupling component of the formula (3.2) are suspended at room temperature in 300 ml of water and this suspension is added to the suspension of the diazonium compound. The pH of the suspension is brought to 2 by adding sodium acetate. It is stirred at room temperature for 5 hours and a saturated solution of 125 g of copper(II) sulphate pentahydrate in water is added. The solid of the formula (4.2)

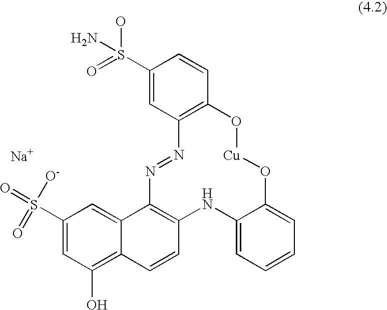

is isolated; the product is converted into a neutral solution using sodium hydroxide solution and is freed from all electrolytes by ultrafiltration. The concentrated solution is used to prepare a black inkjet ink.

Listed in the table below are further dyes, together with the hue of the inkjet inks prepared from them.

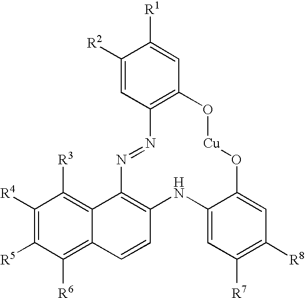

| Ex- | | | | | | | | | |
|---|---|---|---|---|---|---|---|---|---|
| ample | R¹ | R² | R³ | R⁴ | R⁵ | R⁶ | R⁷ | R⁸ | Hue |
| 3 | H | SO₂NH₂ | OH | H | SO₃Na | H | H | H | blue |
| 4 | H | SO₃Na | H | SO₃Na | H | H | H | H | blue |
| 5 | H | SO₃Na | H | H | SO₃Na | H | H | H | blue |
| 6 | H | SO₂NH₂ | OH | H | SO₃Na | H | SO₃Na | H | blue |
| 7 | SO₂N(CH₃)₂ | H | OH | H | SO₃Na | H | H | H | black |
| 8 | H | SO₃Na | SO₃Na | H | OH | H | H | SO₂C₂H₄OH | black |

9) 94.5 g of 2-aminophenol-4-sulphonamide are introduced into an initial charge of 300 ml of water, 75 ml of hydrochloric acid (30%) and 150 g of ice, the components are stirred together and diazotization is performed by adding 35 g of sodium nitrite. 205 g of the coupling component of the formula (3.5) are suspended at room temperature in 300 ml of water and this suspension is added to the suspension of the diazonium compound. The pH of the suspension is brought to 2 by adding sodium acetate. The mixture is stirred at room temperature for 5 hours and then the coupling product is precipitated by adding sodium chloride and isolated.

26.8 g of hexaamminecobalt(III) chloride are dissolved in 100 ml of water and at 50° C. a suspension of 60.9 g of the coupling product is added, the pH being held at 8 by adding aqueous ammonia solution. The complexation product is isolated, the paste is stirred into 1000 ml of water, and, at 60° C. and a pH of 8-8.5, lithium hydroxide is added until the ammonia has been largely expelled. The resulting solution is freed from all electrolytes by ultrafiltration. The concentrated solution of the dye of the formula (4.3) is used to prepare a black inkjet ink.

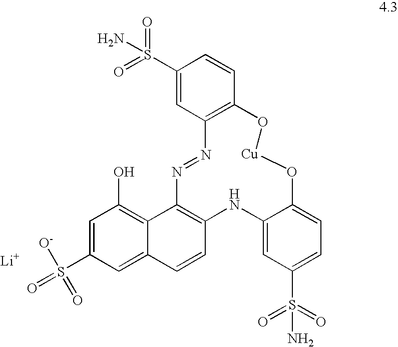

10) Replacing the coupling component used in Example 9 of the formula (3.5) with an equimolar amount of the component of the formula (3.7) gives a solution of the dye of the formula (4.4) which is likewise used to prepare a black inkjet ink.

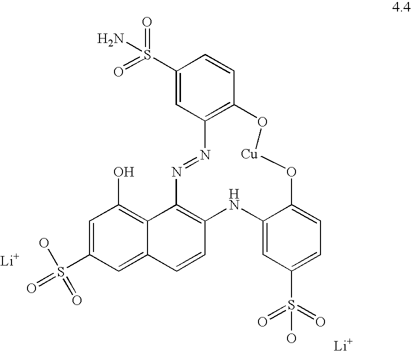

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Compounds of the formula (I) 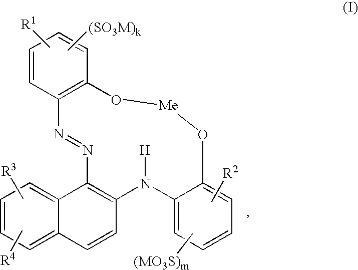
in which
R¹ and R² independently of one another stand for hydrogen or an arbitrary radical,
R³ denotes hydrogen, hydroxyl, carboxyl or SO₃M,
R⁴ denotes hydrogen or SO₃M,
k and m independently of one another denote 0 or 1,
Me stands for copper, cobalt, nickel or chromium, and
M represents hydrogen, alkali metal, or optionally substituted ammonium.

2. Compounds according to claim 1, wherein R¹ and R² independently of one another stand for hydrogen or a radical, independently of one another, selected from the group consisting, chloro, nitro, C₁-C₄ alkyl, C₁-C₄ alkoxy, carboxyl, sulphamoyl, mono- or dialkylsulphamoyl, optionally substituted alkylsulphonyl, and SO₃M.

3. Compounds according to claim 1, which are of the formula (Ia) or (Ib) 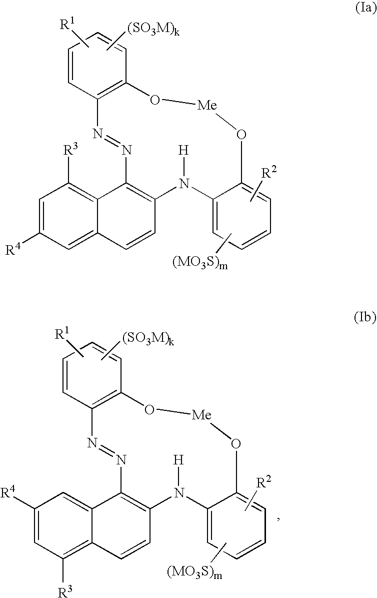
in each of which
k, m, Me and M are as defined in claim 1,
R³ stands for hydrogen or hydroxyl,
R⁴ stands for sulpho and
R¹ and R² independently of one another stand for hydrogen or sulphamoyl.

4. Compounds according to claim 1 which are of the formula

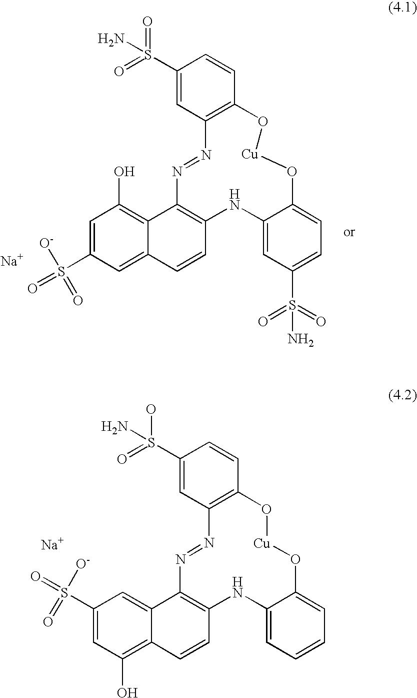

5. Process for preparing compounds according to claim 1, comprising diazotizing an amino compound of the formula (II) 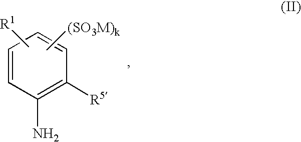
in which
R⁵′ denotes hydrogen, methoxy or hydroxyl, and
M, R¹ and k are as defined in claim 1,
coupling the resulting product with a compound of the formula III 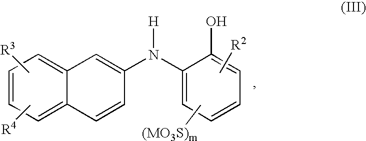
in which
R², R³, R⁴, M and m are as defined in claim 1,
to give a compound of the formula (VI) 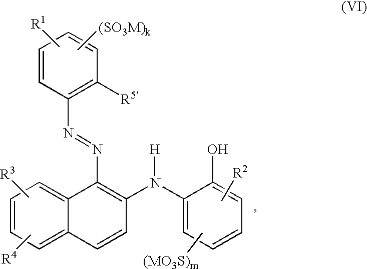
in which
M, R¹, R², R³, R⁴, R⁵′, m and k are as defined above,
and subsequently reacting the compound (VI) with copper, cobalt or chromium donors.

6. Compounds of the formula (VI) 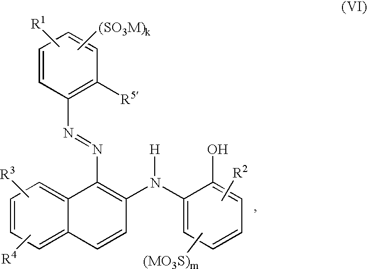
in which
M, R¹, R², R³, R⁴, R⁵′, m and k are as defined in claim 5.

7. Process for preparing compounds according to claim 6, comprising diazotizing an amino compound of the formula (II) 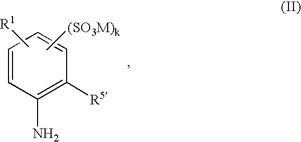
in which
R⁵′ denotes hydrogen, methoxy or hydroxyl and
M, R¹ and k are as defined in claim 6,
and coupling the resulting product with a compound of the formula (III) 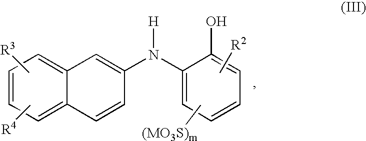
in which
R², R³, R⁴, M and m are as defined in claim 6.

8. Process for preparing compounds of the formula (III), comprising reacting compounds of the formula (IV) 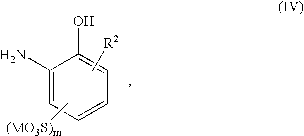
in which
M, R² and m are as defined in claim 5,
in the presence of sodium hydrogen sulphite in an aqueous medium at a temperature from 80° C. to 130° C. with naphthols or naphthylamines of the formula (V) 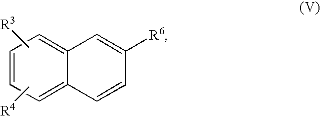
in which
R³ and R⁴ are as defined in claim 4 and
R⁶ denotes hydroxyl or amino.

9. Aqueous dye preparations comprising at least one compound according to claim 1.

10. Aqueous dye preparations according to claim 9 containing from 0.5 to 20% by weight of a compound according to claim 1 and from 80 to 99.5% by weight of water and/or solvents.

11. A method of preparing a recording fluid for inkjet processes comprising incorporating the compounds according to claim 1.

12. A method of inkjet printing wherein the aqueous dye preparations according to claim 9 is applied as recording fluid.
